(19) United States
(12) Patent Application Publication
(10) Pub. No.: US 2004/0105534 A1
(43) Pub. Date: Jun. 3, 2004

(54) System and method for providing informative communication

(75) Inventor: Anthony Dezonno, Bloomingdale, IL (US)

Correspondence Address: James A. Scheer, 22nd Floor, 120 South Riverside Plaza, Chicago, IL, 60606-3945, US

(73) Assignee: Rockwell Electronic Commerce Technologies, LLC, Wood Dale, IL

(21) Appl. No.: 10/648,923

(22) Filed: Aug. 27, 2003

Related U.S. Application Data
(63) Continuation-in-part of application No. 09/664,620, filed on Sep. 19, 2000.

(51) Int. Cl. H04M 15/00; H04M 1/00

(52) U.S. Cl. 379/114.13; 379/373.01

(57) ABSTRACT

A system and method for providing informative communications when a connection is being established between a first communications device and a second communications device. The method includes suppressing an audio tone notifying a user that a connection is being established and substituting information unrelated to the suppressed audio tone to the user while the connection is being established. The information includes advertisements, music, movie clips, news headlines, sports scores, stock quotes, weather, time of day, calendar reminders, horoscopes, and inspirational sayings. Such information is more informative to the user than dial tones and therefore are suppressed in an embodiment of the current invention.

### CROSS REFERENCE TO RELATED PATENT APPLICATIONS

The present application is a continuation-in-part of U.S. patent application Ser. No. 09/664,620 filed on Sept. 19, 2000.

### TECHNICAL FIELD

This invention relates in general to the field of communications devices and, more particularly, to the communication used by such devices.

### BACKGROUND

As is known, communications devices such as mobile apparatuses, cellular telephones, computers or facsimile machines require devices to send and receive information over a communications network, such as the Public Switched Telephone Network (PSTN). To establish a communication link between two computers, a modem of the initiating computer must “handshake” with a modem of the remote computer. Handshaking is the process by which two modems connect and exchange information related to modem capabilities including but not limited to desired data rate, type of error correction, rate of compression, etc. When establishing a communication link between two cellular telephones, a receiving telephone emits a notification signal, such as a ringing tone, to alert a user of the telephone that a call is being received. During the connection process between two communications devices, the user may hear dialing, ringing, or high tones notifying the user of an impending communication. However, beyond notification, the user does not care about the audio tones and often finds them to be annoying. Thus, while the existing method of providing informative communication is functional, it is often annoying to a user. Accordingly, a need exists for a better method of providing informative communication.

### SUMMARY

In one embodiment of the present invention, a system and method for providing informative communications when a connection is being established between a first communications device and a second communications device. The method includes suppressing an audio tone notifying a user that a connection is being established and substituting information unrelated to the suppressed audio tone to the user while the connection is being established. The information includes advertisements, music, movie clips, news headlines, sports scores, stock quotes, weather, time of day, calendar reminders, horoscopes, and inspirational sayings. Such information is more informative to the user than dial tones and therefore is suppressed in an embodiment of the current invention. The information may be static or dynamically updated so that a user is presented with new information upon each connection.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a diagram illustrating an example of a communication system utilizing two communications devices.

FIG. 2 is a diagram illustrating another example of a communication system utilizing two communications devices.

FIG. 3 is a simplified functional diagram illustrating an exemplary embodiment of a communications device of FIG. 2.

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications, and equivalents included within the spirit and scope of the invention as defined by the appended claims.

### DETAILED DESCRIPTION

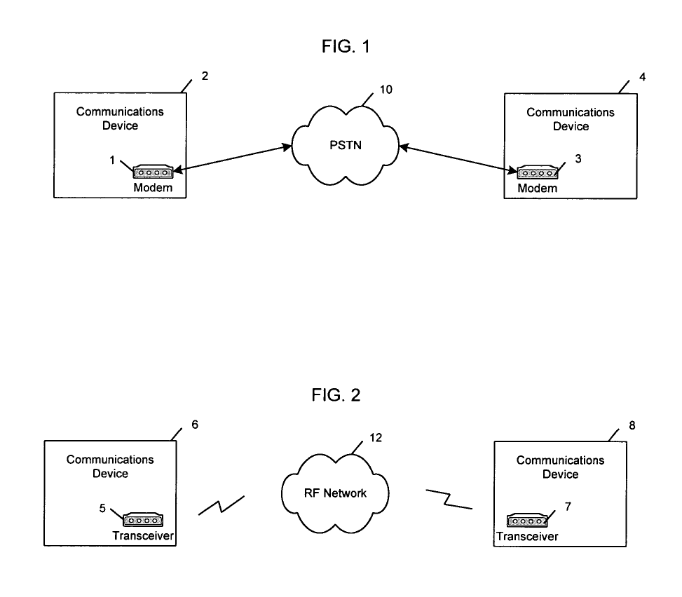

Referring to the drawings, FIG. 1 depicts a general environment in which an example embodiment of the invention may operate. In the embodiment of FIG. 1, when communications devices 2, 4 wish to exchange digital information through a Public Switched Telephone Network (PSTN) 10, they may do so through the use of modems 1, 3. Modems 1, 3 function to establish a connection between the communications devices 2, 4. Another general environment in which an example embodiment of the invention may operate is shown in FIG. 2. When communications devices 6, 8 which to communicate through a radio frequency (RF) system 12, they may do so through the use of transceivers 5, 7. As shown in FIG. 2, whether communications occurs through the PSTN 10 or via the RF system 12, a connection between the communications devices 1, 2, 3, 4 must be established.

Typically, when one communications device 2 desires to communicate with another communications device 4, the devices 2, 4 use modems 1, 3 connected one-to-another through a communications network, for example, a PSTN 10. In the illustrated embodiment of FIG. 1, communications device 2 sends information in digital form to an attached modem 1, which converts the digital information to analog form. The modem 1 then sends the analog information through the PSTN 10 to a second modem 3 that is connected to a second communications device 4. The second modem 3 converts the analog information back into digital information and sends the information in digital form to the attached communications device 4. Further, the communications devices 2, 4 can simultaneously serve as senders and receivers of information. For example, in one embodiment, communications device 2 can simultaneously send information to communications device 4 and receive information from communications device 4.

Communications devices 2, 4 may function as intelligent machines that communicate with each other. In an exemplary embodiment, any commercially available computer may be regarded as the type of communications device contemplated herein. Further examples of communications devices include, but are not limited to notebook computers, computer servers, computer workstations, facsimile machines, personal digital assistants (PDAs), hand-held computers, wireless communication devices and palmtops. Further, a wireless communication device includes cellular telephones and other mobile devices that allow for communication using radio frequencies.

When a communications device 6 desires to communicate with another communications device 8, the communications devices 6, 8 use transceivers 5, 7 to establish a connection via the RF system 12. In the illustrated embodiment of FIG. 2, communications device 6 sends information to an attached transceiver 5 which sends the information through the RF system 12 to a second transceiver 7 that is connected to a second communications device 8. The second transceiver 8 converts the information and sends the information to the attached communications device 8. The communications devices 6, 8 can simultaneously serve as senders and receivers of information. For example, in one embodiment, communications device 6 can simultaneously send information to communications device 8 and receive information from communications device 8.

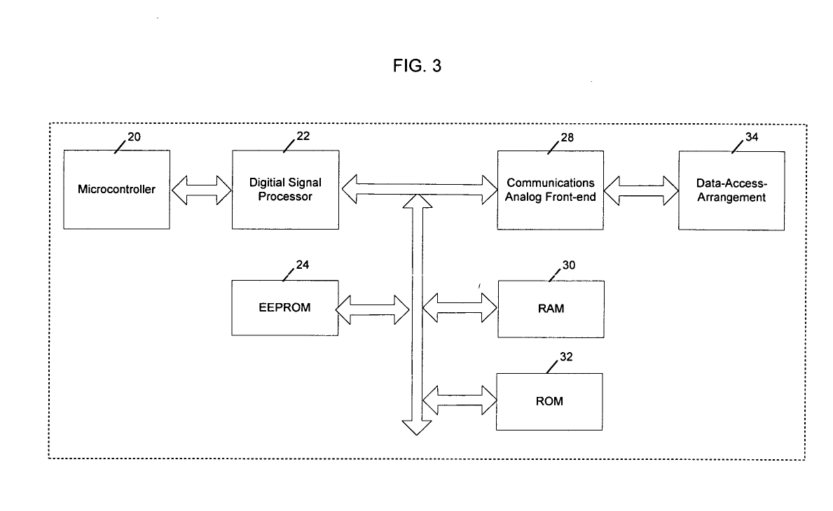

In an exemplary embodiment illustrated in FIG. 3, transceiver 5 includes a microcontroller 20, a digital signal processor 22, memory 24, 30, 32, communications analog front-end 28, and a data-access-arrangement 34. Further, an exemplary transceiver architecture may include the functionality of the microcontroller 20, the digital signal processor 22, the communications analog front-end 28 and the data-access-arrangement 34 in one integrated circuit. In one embodiment, communications devices 2, 4, 6, 8 generate audio tones to notify a user of a communication. As used herein, a communication is information sent between two communication devices. For example, a telephone call, an email message, and a voicemail message are all types of communication. The sound of the audio tones may be heard by the user of the communications device 2, 4, 6, 8 when audio tones are sent to a speaker associated with the communications device 2, 4, 6, 8.

In an exemplary embodiment, communications device 6 initiates a communication, e.g. a telephone call, by dialing a telephone number associated with communications device 8. As the telephone call is delivered to the receiving communication device 8, the communications device 6 presents useful information to the user from files stored in memory (e.g. 30), or alternately from some other storage device (not shown). Once a connection is established between communications device 6 and the communications device 8, the microcontroller 20 may terminate the presentation of useful information.

Further, the useful information may be visual, audio, or audio-visual. For example, visual information may include an advertisement shown on a screen (e.g., a display of the cellular telephone) or other display device associated with communications device 6 while audio information may include advertising messages played through a sound transducer associated with communications device 6.

Useful information that may be presented to the user may include, but is not limited to, advertisements, music, movie clips, news headlines, sports scores, stock quotes, weather, time of day, calendar reminders, horoscopes, system status, messages including voice or e-mail messages, and inspirational sayings. Further, the information may include verbal messages indicating the progress of the handshake negotiation such as “Negotiating Baud Rate” and “Data Connection Established”. Further the information which is presented to the user may vary depending on factors, such as the time of day. For example, if it is morning the information may comprise the message, “Good Morning”, and if it is afternoon, the information may comprise the message “Good Afternoon.”

In an alternative embodiment, the user may switch between hearing useful information and hearing audio tones indicating a communication. Alternating between the two modes may, for example, be accomplished by pressing a softkey on the keypad of communications device 6 or by clicking on a monitor of the communications device 6 with an electronic pen or stylus.

In one embodiment, the useful information is not delivered until a communication is received, while in another embodiment the useful information is delivered immediately upon placement of a communication. In one such embodiment, dial tones are presented to the user when a user is making a call, since dialing indicates a call. In such an embodiment, as the communications device is dialing and attempting to establish a connection, useful information is presented to the user. As mentioned above, useful information may include, but is not limited to, advertisements, music, movie clips, news headlines, sports scores, stock quotes, weather, time of day, calendar reminders, horoscopes, messages, and inspirational sayings.

The information may be either static or dynamic. If the information is static, the same message is presented to the user upon each communication attempt. For example, a commercially available cellular telephone may emit distinctive tones identifying itself or play a well known sequence of musical notes. If the information is dynamic, then it is updated and changed at automatic intervals. The intervals may include a predetermined time, such as once a week, once a day, or may be every connection or disconnection.

Information may be stored in the communications device 2, 4, 6, 8. Information that cannot be changed may be stored in non-volatile memory, such as read-only memory (ROM) (e.g., ROM 32) or programmable read-only memory (PROM) (e.g., EEPROM 24) located in the communications device 2, 4, 6, 8. The information may be presented to the user through a speaker in the communications device 2, 4, 6, 8. Information that can be changed may be stored in volatile memory, such as random access memory (RAM) in the communications device.

Upon establishing a communication with another communications device 2, 4, 6, 8, either the communication initiating communications device 2, 4, 6, 8 or the communication receiving communications device 2, 4, 6, 8 may subsequently receive new information from an outside source. The outside source can be any local or remote source capable of providing the new information such as a local or remote storage device, a local or remote information server, or another communications device 2, 4, 6, 8. The new information may be stored in the communications device 2, 4, 6, 8. This new information may be presented to the user in a subsequent attempt to establish a communication with another communications device 2, 4, 6, 8. For example, during a current communication process, the user may be presented with an advertisement message that was downloaded during a previous communication. Upon completion of the current communication, a new advertisement message may be downloaded replacing the prior message. In the user's next attempt to establish a communication, this new advertisement message would be presented to the user. In one embodiment of the invention, upon completion of a current communication, the communications device 2, 4, 6, 8 may retrieve new information from an information server and download and store the new information.

Information may also be configurable. In an exemplary embodiment of the present invention, the communications device 2, 4, 6, 8 comprises a software portion that enables the user to configure the information according to the user's preferences. The software portion may offer the user a choice of choosing one of several stored audio options. For example, an exemplary embodiment may offer the user the ability to choose between different types of information. For example, if the user wishes the listen to music, the user is given music when the modems are connecting. If the user wishes to listen to current headlines, current headlines are played when the modems are connecting. Further, such configurability can be implemented in an embodiment of the invention regardless of whether the information is static or dynamic. Thus, user's preferences are information that the user would like to receive, including music, hobbies, sports, occupation, news, science, and business. The information can also be automatically configured based upon a profile of the user generated by, for example, monitoring the user's use of the communications device 2, 4, 6, 8 (e.g., purchase of music, etc. on the internet).

In an exemplary embodiment that implements dynamic information the communications devices 2, 4, 6, 8 may also comprise a server that provides new information to the user upon request. Thus when the communications device 2, 4, 6, 8 is initiating a communication, a software portion may request that the server provide new information to the communications device 2, 4, 6, 8. In one embodiment, the server may stream timely information to the communications device 2, 4, 6, 8. In an alternative embodiment, the server may be only accessible to the communications device 2, 4, 6, 8 upon connection with another communications device 2, 4, 6, 8. As discussed earlier, in this embodiment, once a communication is established, the software portion will request updated information from the server through the communication. The communications device 2, 4, 6, 8 will receive the information and store it in the communications device 2, 4, 6, 8. The server will subsequently present the new information to the user during future communications until it is once again updated.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

I claim:

1. A method for providing informative communication when a connection is being established between a first communications device and a second communications device comprising:
suppressing at least one audio tone notifying a user of a first communications device that a connection is being established; and
substituting information unrelated to the at least one suppressed audio tone to the user of the first communications device while the connection is being established.

2. The method for providing informative communication as in claim 1 wherein the information includes advertisements, music, movie clips, news headlines, sports scores, stock quotes, weather, time of day, calendar reminders, horoscopes, messages, and inspirational sayings.

3. The method for providing informative communication as in claim 1 wherein the information is conveyed in audio, visual, or audio-visual format to the user.

4. The method for providing informative communication as in claim 1 wherein the information comprises verbal messages describing the connection process.

5. The method for providing informative communication as in claim 1 wherein the information comprises visual information shown on a display associated with either the first or the second communications device.

6. The method for providing informative communication as in claim 1 wherein the information is configurable according to the user's preferences.

7. The method for providing informative communication as in claim 6 wherein preferences are types of information that the user would like to receive including music, hobbies, sports, occupation, news, science, and business.

8. The method for providing informative communication as in claim 1 wherein the step of suppressing further comprises impeding a communications system generated dial tone from being heard by a user of either the first or second communications device.

9. The method for providing informative communication as in claim 1 wherein the step of substituting further comprises sending the information to at least one speaker associated with the first communications device.

10. The method for providing informative communication as in claim 1 wherein the step of substituting further comprises presenting the information on a display device associated with either the first or the second communications device.

11. The method for providing informative communications as in claim 10 wherein the display device is chosen from the group consisting of CRT monitor, LCD display, active matrix display and LED display.

12. The method for providing informative communication as in claim 1 further comprising providing the user with ability to switch between receiving the suppressed at least one audio tone and receiving substituted information.

13. The method for providing informative communication as in claim 12 wherein the step of receiving the suppressed at least one audio tone further comprises sending to at least one speaker associated with either the first or second communications device a communications system generated dial tone.

14. The method for providing informative communication as in claim 1 wherein the information is static.

15. The method for providing informative communication as in claim 1 wherein the information is dynamic.

16. The method for providing informative communication as in claim 15 further comprising:
requesting new information from an information server;
receiving the new information; and
storing the new information in either the first or the second communications device until it is presented to the user.

17. A method for providing informative communications to a user of a first communications device and first transceiver when the first communications device is establishing a connection with a second communications device and second transceiver comprising:
suppressing dial tones notifying a user of connection being established between the first and second transceivers; and
substituting information unrelated to the suppressed dial tones to the user of the first communications device and first transceiver while the connection is being established.

18. A system for providing informative communications when a connection is being established between communications devices comprising memory, a display, a speaker and a transceiver comprising:
means for at least one audio tone notifying a user of a communications device that a connection is being established; and
means for substituting information unrelated to the at least one suppressed audio tone to a user of the communications device while the connection is being established.

19. The system for providing informative communication as in claim 18 wherein the information includes advertisements, music, movie clips, news headlines, sports scores, stock quotes, weather, time of day, calendar reminders, horoscopes, messages, and inspirational sayings.

20. The system for providing informative communication as in claim 18 wherein the information is conveyed in audio, visual, or audio-visual format to the user.

21. The system for providing informative communication as in claim 18 wherein the information comprises verbal messages describing the connection process.

22. The system for providing informative communication as in claim 18 wherein the information comprises visual messages shown on a display associated with the at least one communications device.

23. The system for providing informative communication as in claim 18 wherein the information is configurable according to the user's preferences.

24. The system for providing informative communication as in claim 23 wherein preferences are types of information that the user would like to receive including music, hobbies, sports, occupation, news, science, and business.

25. The system for providing informative communication as in claim 18 wherein the means for suppressing further comprises means for impeding a communications system generated dial tone from being heard by the user of the communications device.

26. The system for substituting informative communication as in claim 18 wherein the means for substituting further comprises means for sending the information to at least one speaker associated with the communications device.

27. The system for substituting informative communication as in claim 18 wherein the means for substituting further comprises means for sending the information to a display associated with the communications device.

28. The system for providing informative communication as in claim 27 wherein the display is chosen from the group consisting of CRT monitor, LCD display, active matrix display and LED display.

29. The system for providing informative communication as in claim 18 further comprising means for providing the user with ability to switch between receiving the suppressed audio tones and receiving substituted information.

30. The system for providing informative communication as in claim 29 wherein means for receiving the suppressed audio tones further comprises sending to at least one speaker associated with the communications device a communications system generated dial tone.

31. The system for providing informative communication as in claim 18 wherein the information is static.

32. The system for providing informative communication as in claim 18 wherein the information is dynamic.

33. The system for providing informative communication as in claim 15 further comprising:
means for requesting new information from an information server;
means for receiving the new information; and
means for storing the new information in the communications device until it is presented to the user.

34. A system for providing informative communications to a user of a first communications device and first transceiver when the first communications device is establishing a connection with a second communications device and second transceiver comprising:
means for suppressing at least one audio tone notifying a user of a first communications device that a connection is being established; and
means for substituting information unrelated to the at least one suppressed audio tone to the user of the first communications device and first transceiver while the connection is being established.

35. A system for providing informative communications when a connection is being established between communications devices comprising memory, a display, a speaker and a transceiver comprising:
a tone generator to send dial tones to a user of a communications device which upon demand also sends dial tones to the speaker; and
memory for storing information; and
a communicator which presents the stored information to the user while the connection is being established.

36. The system for providing informative communication as in claim 35 wherein the information includes advertisements, music, movie clips, news headlines, sports scores, stock quotes, weather, time of day, calendar reminders, horoscopes, messages, and inspirational sayings.

37. The system for providing informative communication as in claim 35 wherein the information is conveyed in audio, visual, or audio-visual format to the user.

38. The system for providing informative communication as in claim 35 wherein the information comprises verbal messages describing the connection process.

39. The system for providing informative communication as in claim 35 wherein the information comprises visual information shown on the display associated with the communications device.

40. The system for providing informative communication as in claim 35 wherein the information is configurable according to the user's preferences.

41. The system for providing informative communication as in claim 40 wherein preferences are types of information that the user would like to receive, including music, hobbies, sports, occupation, news, science, and business.

42. The system for providing informative communication as in claim 35 wherein the stored information is shown on the display of the communications device.

43. The system for providing informative communication as in claim 42 wherein the display is chosen from the group consisting of CRT monitor, LCD display, active matrix display, and LED display.

44. The system for providing informative communication as in claim 35 further comprising a switch to change between receiving the suppressed dial tones and receiving substituted information.

45. The system for providing informative communication as in claim 44 wherein the dial tones and the information are sent to the speaker.

46. The system for providing informative communication as in claim 35 wherein the information is static.

47. The system for providing informative communication as in claim 35 wherein the information is dynamic.

48. The system for providing informative communication as in claim 47 further comprising:
a requestor of information from an information server;
a receiver of the requested information; and
memory for storing the requested information in the communications device.

49. The system for providing informative communication as in claim 48 wherein the requestor and receiver are the transceiver of the communications device.

50. The system for providing informative communication as in claim 48 wherein the requester and receiver are the central processor of the communications device.
